(19) United States
(12) Patent Application Publication
(10) Pub. No.: US 2011/0221700 A1
(43) Pub. Date: Sep. 15, 2011

(54) MUTUAL CAPACITANCE TOUCH SCREEN WITH ELECTRODES ARRANGED ON DUAL CONDUCTIVE MATERIAL FILMS

(76) Inventors: Michael Mo, Shenzhen (CN); JK Zhang, Shenzhen (CN); Ling Peng, Shenzhen (CN)

(21) Appl. No.: 13/045,785

(22) Filed: Mar. 11, 2011

(30) Foreign Application Priority Data
Mar. 12, 2010 (CN) 201010149156.8

(51) Int. Cl. G06F 3/045

(52) U.S. Cl. 345/174

(57) ABSTRACT

A mutual capacitance touch screen with electrodes arranged on dual conductive material films, which comprises an upper electrode film and a lower electrode film, and the two electrode films respectively comprise an electrode plane made of transparent conductive materials and an insulated plane made of transparent insulating materials. The insulated planes of the two electrode films are fused together. Lower electrode plates are arranged on the electrode plane of the lower electrode film separately, and shielding electrode plates are arranged in the clearance between the lower electrode plates. Therefore, the lower electrode plates and the shielding electrode plates are distributed to the whole electrode plane of the lower electrode film. The touch screen of the present invention can isolate interference from the display screen in the conditions that the thickness is not increased and the shielding electrode film is not required to be arranged individually. Therefore, the manufacturing cost of the touch screen is reduced.

### TECHNICAL FIELD

The present invention relates to a data input device converting action message to required electrical signals, particularly to a capacitive touch screen with electrodes arranged on films.

### BACKGROUND ART

The mutual capacitance touch screen in the prior art comprises driving electrodes electrically connected to peripheral excitation signal modules of the touch screen, and sensing electrodes electrically connected to peripheral sensor signal detection processing modules of the touch screen, and mutual capacitance is formed between the driving electrodes and the sensing electrodes. When the surface of the mutual capacitance touch screen is touched, the mutual capacitance value within areas using the touch point as center will be changed, thereby converting the touch action message to electrical signals. Coordinate data of the touch action center can be obtained by processing data of capacitance value changing areas, then associated data processing equipment can identify the position on the display screen according to the coordinate data of the touch action center, and the position corresponds to the touch action and is covered with the touch screen. Therefore, related functions or operations corresponding to the position on the display screen are completed.

In order to decrease the thickness of the touch screen, the prior art developed an electrode film which comprises an electrode plane made of transparent conductive materials and an insulated plane made of transparent insulating materials. The mutual capacitance touch screen in the prior art is made of two electrode films. As shown in FIG. 5, the electrode plane of an upper electrode film 100′ is provided with upper electrode plates 111′, and the electrode plane of a lower electrode film 200′ is provided with lower electrode plates 211′. The insulated plane 120′ of the upper electrode film 100′ and the insulated plane 220′ of the lower electrode film 200′ are fused together. The upper electrode plates 111′ or the lower electrode plates 211′ are electrically connected to the peripheral excitation signal modules of the touch screen, and the other electrode plates are electrically connected to the peripheral sensor signal detection processing modules of the touch screen, thereby forming the mutual capacitance between the upper electrode plates 111′ and the lower electrode plates 211′. Generally, the mutual capacitance is distributed to the whole touch screen in the farm of orthogonal array. The mutual capacitance touch screen made of the electrode films is easily subject to external influence since the electrode films are very thin. Particularly, the touch screen is installed on the surface of a display screen 400, the lower electrode film 200′ covers the display plane of the display screen 400, and the touch screen is easily subject to interference from the display screen 400. The prior art solves the interference problem by adopting the solution that a shielding electrode film 300′ as shown in FIG. 5 is arranged below the electrode film 200′ and comprises an shielding electrode 311′ made of transparent conductive materials in whole and an insulated plane 320′ made of transparent insulating materials, wherein the shielding electrode 311′ is directly earthed or electrically connected to a DC power source. The shielding electrode film 300′ can isolate interference from the display screen 400. However, the installation of the shielding electrode film 300′ not only increases the manufacturing cost of the mutual capacitance touch screen but also increases the thickness of the touch screen, which does not conform to the development trend that the touch screen shall be thinner.

### Invention Contents

The technical problem the present invention aims to settle is to avoid the defects of the prior art to provide a mutual capacitance touch screen with electrodes arranged on dual conductive material films, the touch screen can isolate interference from the display screen in the conditions that the thickness is not increased and the shielding electrode film is not required to be arranged individually.

The invention adopts the following technical solution to solve the technical problems:

The invention designs and manufactures a mutual capacitance touch screen with electrodes arranged on dual conductive material films, which comprises an upper electrode film and a lower electrode film, and the two electrode films respectively comprise electrode planes made of transparent conductive materials and insulated planes made of transparent insulating materials. The insulated planes of the two electrode films are fused together. In particular, lower electrode plates are arranged on the electrode plane of the lower electrode film separately, and shielding electrode plates are arranged in the clearance between the lower electrode plates so that the lower electrode plates and the shielding electrode plates are distributed to the whole electrode plane of the lower electrode film. All the shielding electrode plates are directly earthed or electrically connected to a DC power source in series and/or in parallel. The electrode plane of the lower electrode film is used for covering the display screen. The electrode plane of the upper electrode film is provided with the upper electrode plates. The upper electrode plates or the lower electrode plates are electrically connected to the peripheral excitation signal modules of the touch screen in series and/or in parallel, and the other electrode plates are electrically connected to the peripheral sensor signal detection processing modules of the touch screen in series and/or in parallel.

The upper electrode plane adopts the following specific structure, and is located in the clearance between the lower electrode plates over against the lower electrode film.

On the basis of the specific structure of the upper electrode plates, the invention also adopts the following solution that the electrode plane of the upper electrode film is also provided with dummy electrode plates, and each dummy electrode plate is in electrical suspending state. Particularly, in the electrode plane of the upper electrode film, the area over against each lower electrode plate are respectively provided with at least one dummy electrode plate, and therefore the upper electrode plates and the dummy electrode plates are distributed to the whole electrode plane of the upper electrode film.

The lower electrode plates shall be used as driving electrode plates, that is to say, the lower electrode plates are electrically connected to the peripheral excitation signal modules of the touch screen in series and/or in parallel, and the upper electrode plates are electrically connected to the peripheral sensor signal detection processing modules of the touch screen in series and/or in parallel.

The two electrode films adopt the following specific structures. The upper electrode plates are connected in series to be at least two upper electrode chains in group, wherein the centroids of the upper electrode plates of each upper electrode chain are in one straight line, and the connecting lines for the electrode plate centroids of the upper electrode chains are parallel mutually. In the same way, the lower electrode plates are connected in series to be at least two lower electrode chains in group, wherein the centroids of the lower electrode plates of each lower electrode chain are in one straight line, and the connecting lines for the electrode plate centroids of the lower electrode chains are parallel mutually. Any connecting line for the electrode plate centroids of the upper electrode chains is perpendicular to any connecting line for the electrode plate centroids of the lower electrode chains.

The upper electrode plates and the lower electrode plates are rectangular, rhombic, or polygonal.

In addition, the transparent conductive materials are Indium Tin Oxide, i.e. ITO, or Antimony Tin Oxide, i.e. ATO, so the upper and lower electrode films are ITO films or ATO films.

Compared with the prior art, the mutual capacitance touch screen with electrodes arranged on dual conductive material films has the technical effects:

The invention ensures that the touch screen is provided with electrode films only, and the shielding electrode plates are arranged on the lower electrode film. Therefore, the invention not only effectively isolates interference from the display screen but also solves the problem that the shielding electrode film is arranged individually in the prior art to increase the thickness of the touch screen, and the invention conforms to the development trend that the touch screen shall be thinner. In addition, the shielding electrode plates and the lower electrode plates complement each other. The shielding electrode plates provided with the shielding electrode film individually are distributed to the whole electrode film. The area of the shielding electrode plates in the invention is obviously decreased, thereby reducing the manufacturing cost of the touch screen.

### DESCRIPTION OF FIGURES

FIG. 1 shows the schematic diagram of the first embodiment of the mutual capacitance touch screen with electrodes arranged on dual conductive material films, comprising:

FIG. 1-1 shows the front view of the orthographic projection of the first embodiment.

FIG. 1-2 shows the rear view of the orthographic projection of the first embodiment.

FIG. 1-3 shows the section view of FIG. 1-1 in A-A direction.

FIG. 2 shows the schematic diagram of the second embodiment of the invention, comprising:

FIG. 2-1 shows the front view of the orthographic projection of the second embodiment.

FIG. 2-2 shows the rear view of the orthographic projection of the second embodiment.

FIG. 2-3 shows the section view of FIG. 2-1 in B-B direction.

FIG. 3 shows the schematic diagram of the third embodiment of the invention, comprising:

FIG. 3-1 shows the front view of the orthographic projection of the third embodiment.

FIG. 3-2 shows the rear view of the orthographic projection of the third embodiment.

FIG. 3-3 shows the section view of FIG. 3-1 in C-C direction.

FIG. 4 shows the schematic diagram of the fourth embodiment of the invention, comprising:

FIG. 4-1 shows the front view of the orthographic projection of the fourth embodiment.

FIG. 4-2 shows the rear view of the orthographic projection of the fourth embodiment.

FIG. 4-3 shows the section view of FIG. 3-1 in D-D direction.

FIG. 5 shows the section view of the mutual capacitance touch screen in the prior art.

### MODE OF CARRYING OUT THE INVENTION

The invention is further described hereinafter with reference to embodiments shown in the following figures.

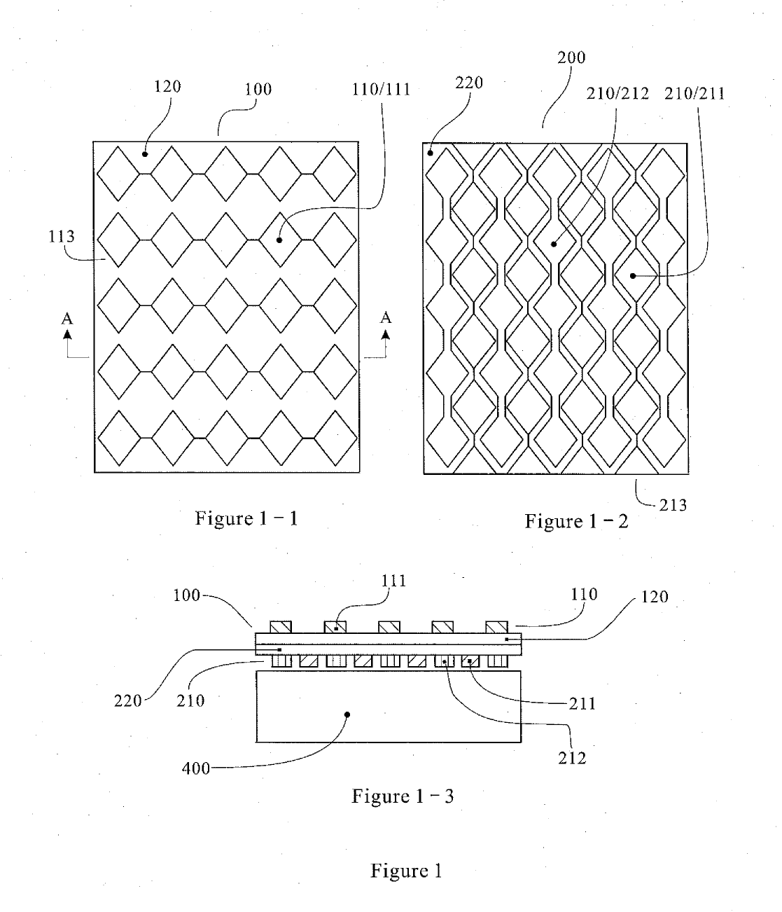

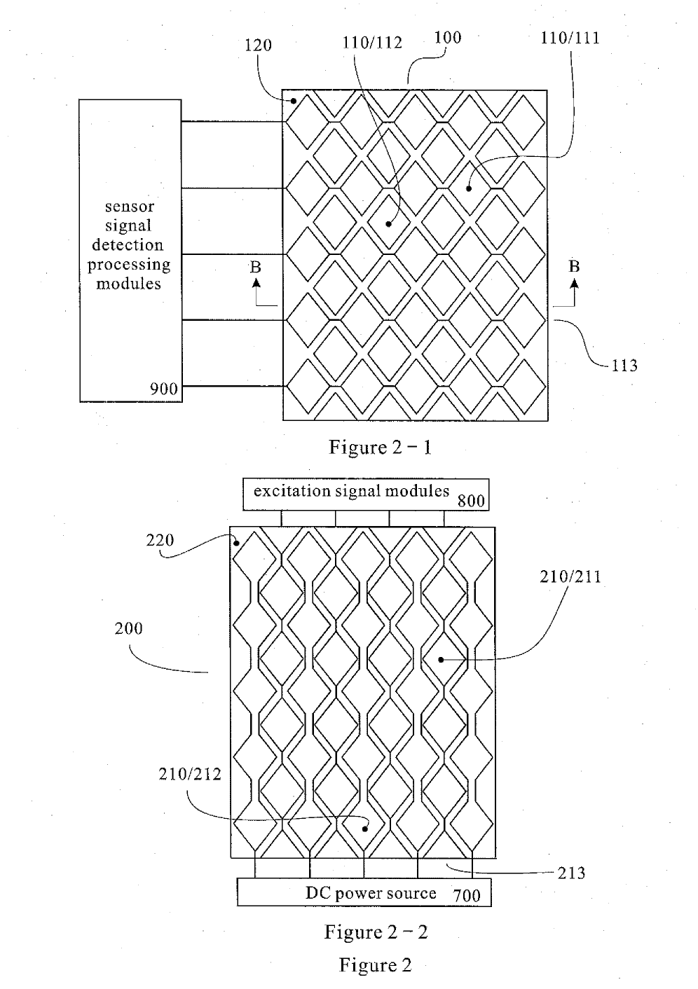

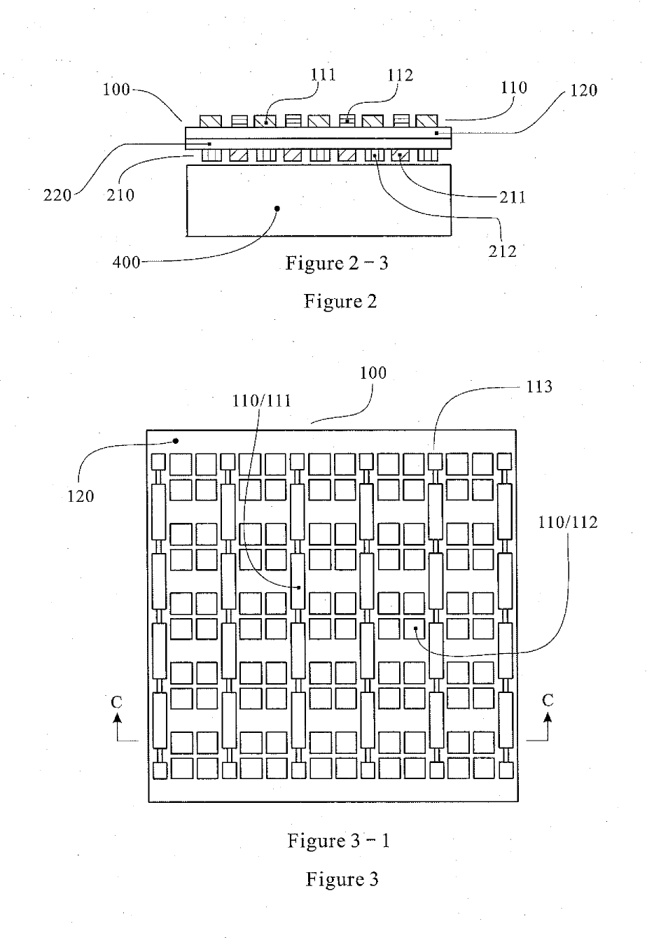

The invention relates to a mutual capacitance touch screen with electrodes arranged on dual conductive material films. As shown in FIG. 1 through FIG. 4, the mutual capacitance touch screen comprises an upper electrode film 100 and a lower electrode film 200, and the two electrode films 100, 200 respectively comprise electrode planes 110, 210 made of transparent conductive materials and insulated planes 120, 220 made of transparent insulating materials 120, 220. The insulated planes 120, 220 of the two electrode films 100, 200 are fused together. Lower electrode plates 211 are arranged on the electrode plane 210 of the lower electrode film 200 separately, and shielding electrode plates 212 are arranged in the clearance between the lower electrode plates 211 so that the lower electrode plates 211 and shielding electrode plates 212 are distributed to the whole electrode plane 210 of the lower electrode film 200. As shown in FIG. 2, all the shielding electrode plates 212 are directly earthed or electrically connected to a DC power source 700 in series and/or in parallel. The electrode plane 210 of the lower electrode film 200 is used for covering the display screen 400. The electrode plane 110 of the upper electrode film 100 is provided with the upper electrode plates 111. The upper electrode plates 111 or the lower electrode plates 211 are electrically connected to peripheral excitation signal modules 800 of the touch screen in series and/or in parallel, and the other electrode plates are electrically connected to the peripheral sensor signal detection processing modules 900 of the touch screen in series and/or in parallel.

The shielding electrode plate 212 and the lower electrode plates 211 are arranged on the electrode plane 210 of the lower electrode film 200 separately, and arranged in complementary mode. Compared with the touch screen in the prior art, firstly, the shielding electrode plates 212 and the lower electrode plates 211 of the invention are both in one lower electrode film 200, thereby reducing one electrode film which is arranged individually in the prior art, the manufacturing cost of the touch screen is reduced, and at the same time, the thickness of the touch screen is not increased. In addition, the shielding electrode plates 212 and the lower electrode plates 211 are arranged in complementary mode, rather than that the shielding electrode plates of the touch screen in the prior art are distributed to the whole electrode film. The total area of the shielding electrode plates 212 of the invention is obviously less than that of the shielding electrode plates in the prior art, thereby reducing the manufacturing cost of the touch screen further.

The upper electrode plates 111 adopt any arrangement mode, preferentially the scheme that the upper electrode plates 111 are not over against the lower electrode plates 211, i. e. like the embodiments of the invention; as shown in FIG. 1 through FIG. 4, the upper electrode plates 111 are located in the clearance between the lower electrode plates 211 over against the lower electrode film 200. The structure makes the area of the upper electrode plates 111 over against the lower electrode plates 211 reduced, so much so that the area is zero, thereby improving effective capacitivity of mutual capacitance to increase sensitivity of the touch screen.

Aiming to further increase the effective capacitivity of the mutual capacitance touch screen, in the second embodiment to the fourth embodiment of the invention, the electrode plane 110 of the upper electrode film 100 is also provided with the dummy electrode plates (112), and each dummy electrode plate 112 is in electrical suspending state as shown in FIG. 2 through FIG. 4. The electrical suspending state means that no electrical connection is among the dummy electrode plates, and the dummy electrode plates are not electrically connected to any peripheral module of the touch screen.

As shown in FIG. 2 through FIG. 4, the dummy electrode plates 112 can be over against the lower electrode plates 211, i. e. in the electrode plane 110 of the upper electrode film 100, the area over against each lower electrode plate 211 are respectively provided with at least one dummy electrode plate 112, and therefore the upper electrode plates 111 and the dummy electrode plates 112 are distributed to the whole electrode plane 110 of the upper electrode film 100.

The upper electrode plates 111 can be used as driving electrodes or sensing electrodes, and the lower electrode plates 211 can be used as driving electrodes or sensing electrodes, which depends on the modules for electrical connection of them. The electrode plate electrically connected to the excitation signal module is the driving electrode, and the electrode plate electrically connected to the sensor signal detection processing module is the sensing electrode. In the second embodiment of the invention, as shown in FIG. 2, the lower electrode plate 211 is electrically connected to the peripheral excitation signal module 800 of the touch screen in series and/or in parallel and the lower electrode plate 211 is used as the driving electrode. The upper electrode plate 111 is electrically connected to the peripheral sensor signal detection processing module 900 of the touch screen in series and/or in parallel and the upper electrode plate 111 is used as the sensing electrode. Certainly, the upper electrode plate 111 and the lower electrode plate 211 can be exchanged, and therefore the touch screen peripheral module electrically connected to them are not specifically limited in the first, third and fourth embodiments.

In the invention, the transparent conductive materials are Indium Tin Oxide, i.e. ITO, or Antimony Tin Oxide, i.e. ATO. If the transparent conductive material is ITO, the upper and lower electrode films 100, 200 are ITO films. If the transparent conductive material is ATO, the upper and lower electrode films 100, 200 are ATO films.

The technical scheme of the invention is described in detail by the following four embodiments, and the electrode plate arrangement of the four embodiments in the invention adopts the following structure:

The upper electrode plates 111 are connected in series to be at least two upper electrode chains 113 in group, wherein the centroids of the upper electrode plates 111 of each upper electrode chain 113 are in one straight line, and the connecting lines for the electrode plate centroids of the upper electrode chains 113 are parallel mutually. The lower electrode plates 211 are also connected in series to be at least two lower electrode chains 213 in group, wherein the centroids of the lower electrode plates 211 of each lower electrode chain 213 are in one straight line, and the connecting lines for the electrode plate centroids of the lower electrode chains 213 are parallel mutually. Any connecting line for the electrode plate centroids of the upper electrode chains 113 is perpendicular to any connecting line for the electrode plate centroids of the lower electrode chains 213.

In the first embodiment of the invention, the upper electrode film 100 is not provided with the dummy electrode plates 112, and the upper electrode plates 111 and the lower electrode plates 211 are rhombic as shown in FIG. 1. The upper electrode plates 111 are connected in series to be a plurality of upper electrode chains 113 laterally in group, wherein the connecting lines for the electrode plate centroids are parallel mutually; the lower electrode plates 211 are connected in series to be a plurality of lower electrode chains 213 longitudinally in group, wherein the connecting lines for the electrode plate centroids are parallel mutually. Any connecting line for the electrode plate centroids of the upper electrode chains 113 is perpendicular to any connecting line for the electrode plate centroids of the lower electrode chains 213. As shown in FIG. 1-3, the touch screen can not be subject to interference from the display screen 400 under the shielding effect of the shielding electrode plate 212, and the shielding electrode film is not required to be arranged individually, so that the touch screen has the thickness as thin as possible, and manufacturing cost is reduced.

In the second embodiment of the invention, compared with the first embodiment, the upper electrode film 100 is provided with the dummy electrode plate 112 as shown in FIG. 2. The dummy electrode plate is in the electrical suspending state so that electric field relay is effected between the upper and lower electrode plates 111, 211, thereby increasing the effective capacitivity of the touch screen further.

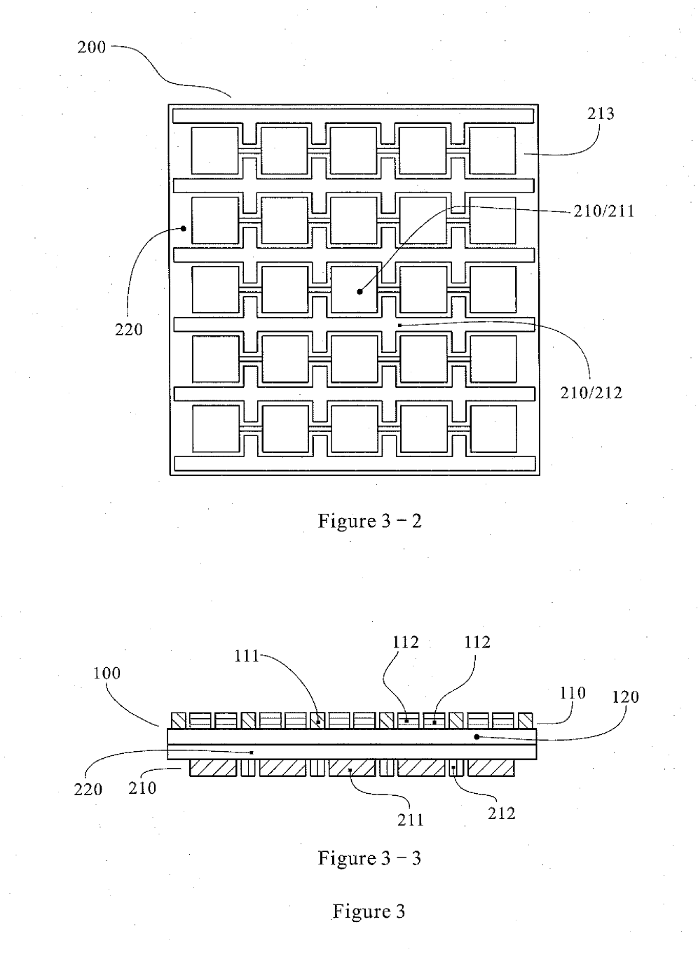

In the third embodiment of the invention, the upper electrode film 100 is provided with the dummy electrode plates 112, and the upper electrode plates 111 and the lower electrode plate 211 are rectangular as shown in FIG. 3. The upper electrode plates 111 are connected in series to be a plurality of upper electrode chains 113 longitudinally in group, wherein the connecting lines for the electrode plate centroids are parallel mutually; the lower electrode plates 211 are connected in series to be a plurality of lower electrode chains 213 laterally in group, wherein the connecting lines for the electrode plate centroids are parallel mutually. Any connecting line for the electrode plate centroids of the upper electrode chains 113 is perpendicular to any connecting line for the electrode plate centroids of the lower electrode chains 213. The dummy electrode plates 112 are over against the lower electrode plates 211, i. e. the electrode plane 110 of the upper electrode film 100 and the area over against each lower electrode plate 211 are respectively provided with four rectangular dummy electrode plates 112, and therefore the upper electrode plates 111 and the dummy electrode plates 112 are distributed to the whole electrode plane 110 of the upper electrode film 100. As shown in FIG. 3-3, the touch screen can not be subject to interference from the display screen 400 under the shielding effect of the shielding electrode plate 212, and the shielding electrode film is not required to be arranged individually, so that the touch screen has the thickness as thin as possible, and the manufacturing cost is reduced.

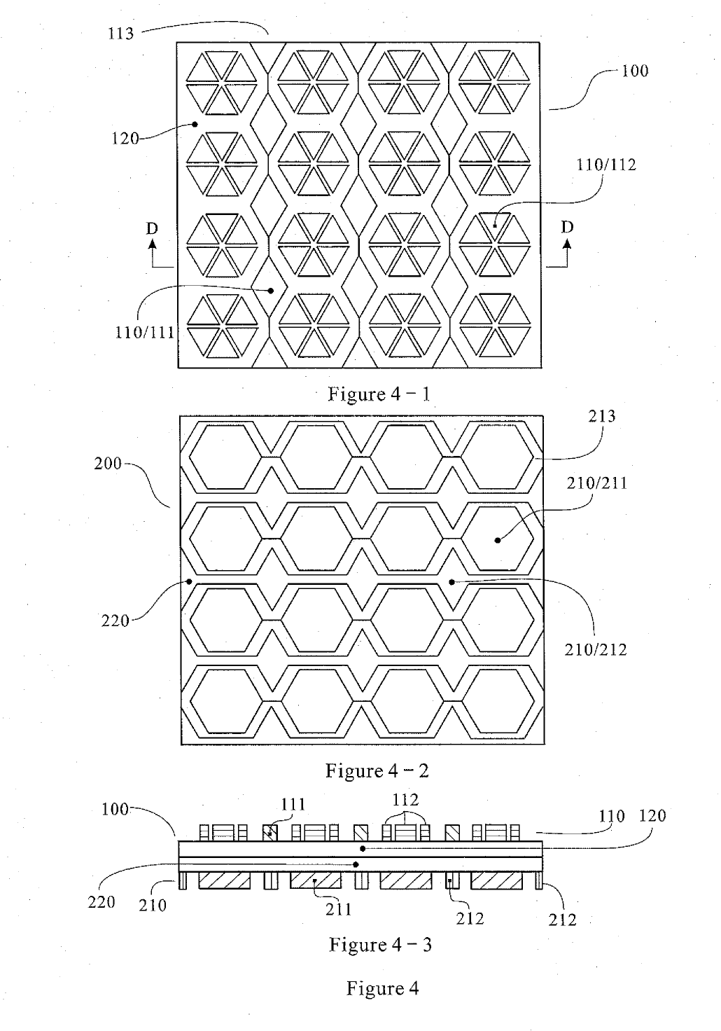

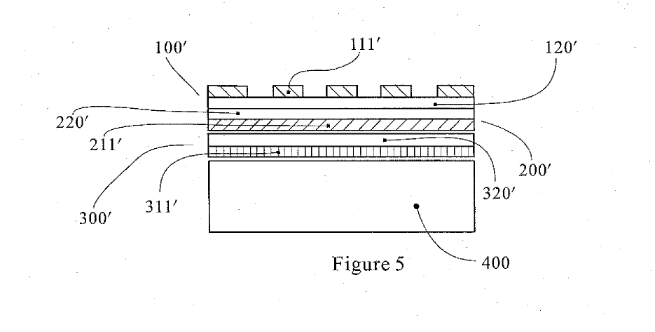

In the fourth embodiment of the invention, the upper electrode film 100 is provided with the dummy electrode plates 112, the upper electrode plates 111 are hexagonal, and the lower electrode plates 211 are rhombic as shown in FIG. 4. The upper electrode plates 111 are connected in series to be a plurality of upper electrode chains 113 longitudinally in group, wherein the connecting lines for the electrode plate centroids are parallel mutually; the lower electrode plates 211 are connected in series to be a plurality of lower electrode chains 213 laterally in group, wherein the connecting lines for the electrode plate centroids are parallel mutually. Any connecting line for the electrode plate centroids of the upper electrode chains 113 is perpendicular to any connecting line for the electrode plate centroids of the lower electrode chains 213. The dummy electrode plates 112 are over against the lower electrode plates 211, i. e. the electrode plane 110 of the upper electrode film 100 and the area over against each lower electrode plates 211 are respectively provided with six triangular dummy electrode plates 112, and therefore the upper electrode plates 111 and the dummy electrode plates 112 are distributed to the whole electrode plane 110 of the upper electrode film 100. As shown in FIG. 3-3, the touch screen can not be subject to interference from the display screen 400 under the shielding effect of the shielding electrode plate 212, and the shielding electrode film is not required to be arranged individually, so that the touch screen has the thickness as thin as possible, and the manufacturing cost is reduced.

1. A mutual capacitance touch screen with electrodes arranged on dual conductive material films comprises an upper electrode film and a lower electrode film, and the two electrode films respectively comprise electrode planes made of transparent conductive materials and insulated planes made of transparent insulating materials; The insulated planes of the two electrode films are fused together; The mutual capacitance touch screen is characterized in that:
Lower electrode plates are arranged on the electrode plane of the lower electrode film separately, and shielding electrode plates are arranged in the clearance between the lower electrode plates so that the lower electrode plates and shielding electrode plates are distributed to the whole electrode plane of the lower electrode film; All the shielding electrode plates are directly earthed or electrically connected to a DC power source in series and/or in parallel; The electrode plane of the lower electrode film is used for covering the display screen;
The electrode plane of the upper electrode film is provided with the upper electrode plates;
The upper electrode plates or the lower electrode plates are electrically connected to peripheral excitation signal modules of the touch screen in series and/or in parallel, and the other electrode plates are electrically connected to the peripheral sensor signal detection processing modules of the touch screen in series and/or in parallel.

2. The mutual capacitance touch screen with electrodes arranged on dual conductive material films according to claim 1 is characterized in that:
The upper electrode plates are located in the clearance between the lower electrode plates over against the lower electrode film.

3. The mutual capacitance touch screen with electrodes arranged on dual conductive material films according to claim 1 is characterized in that:
The electrode plane of the upper electrode film is also provided with the dummy electrode plates, and each dummy electrode plate is in electrical suspending state.

4. The mutual capacitance touch screen with electrodes arranged on dual conductive material films according to claim 2 is characterized in that:
In the electrode plane of the upper electrode film, the area over against each lower electrode plate are respectively provided with at least one dummy electrode plate, and therefore the upper electrode plates and the dummy electrode plates are distributed to the whole electrode plane of the upper electrode film.

5. The mutual capacitance touch screen with electrodes arranged on dual conductive material films according to claim 1 is characterized in that:
The lower electrode plate is electrically connected to the peripheral excitation signal modules of the touch screen in series and/or in parallel;
The upper electrode plates are electrically connected to the peripheral sensor signal detection processing modules of the touch screen in series and/or in parallel.

6. The mutual capacitance touch screen with electrodes arranged on dual conductive material films according to claim 1 is characterized in that:
The upper electrode plates are connected in series to be at least two upper electrode chains in group, wherein the centroids of the upper electrode plates of each upper electrode chain are in one straight line, and the connecting lines for the electrode plate centroids of the upper electrode chains are parallel mutually;
In the same way, the lower electrode plates are also connected in series to be at least two lower electrode chains in group, wherein the centroids of the lower electrode plates of each lower electrode chain are in one straight line, and the connecting lines for the electrode plate centroids of the lower electrode chains are parallel mutually;
Any connecting line for the electrode plate centroids of the upper electrode chains is perpendicular to any connecting line for the electrode plate centroids of the lower electrode chains.

7. The mutual capacitance touch screen with electrodes arranged on dual conductive material films according to claim 1 is characterized in that:
The upper electrode plates and the lower electrode plates are rectangular, rhombic, or polygonal.

8. The mutual capacitance touch screen with electrodes arranged on dual conductive material films according to claim 1 is characterized in that:
The transparent conductive materials are Indium Tin Oxide, i.e. ITO, or Antimony Tin Oxide, i.e. ATO;
Then, the upper and lower electrode films are ITO films or ATO films.
